(19) United States
(12) Patent Application Publication
(10) Pub. No.: US 2013/0092793 A1
(43) Pub. Date: Apr. 18, 2013

(54) AIRCRAFT, AND FASTENING ARRANGEMENT FOR A FLOOR STRUCTURE IN AN AIRCRAFT

(71) Applicant: Stefan Braeutigam, Cham (CH)

(72) Inventor: Stefan Braeutigam, Cham (CH)

(73) Assignee: PREMIUM AEROTEC GMBH, Augsburg (DE)

(21) Appl. No.: 13/640,152

(22) PCT Filed: Apr. 6, 2011
(86) PCT No.: PCT/DE2011/000361

§ 371 Date: Dec. 19, 2012

(30) Foreign Application Priority Data
Apr. 9, 2010 (DE) 10 2010 014 302.2

(51) Int. Cl. B64C 1/06; B64C 1/18

(52) U.S. Cl. CPC B64C 1/061; B64C 1/18
USPC 244/131

(57) ABSTRACT

An aircraft comprising includes a fuselage shell with fuselage frames, a floor structure with transverse and longitudinal beams, and a fastening arrangement for supporting the floor structure on the fuselage shell. The fastening arrangement includes first bars each connecting an end of a transverse beam to a fuselage frame so as to transfer forces extending in a transverse direction between the floor structure and the shell. Second bars each connect an end of a transverse beam to a fuselage frame so as to transfer forces in a longitudinal direction between the floor structure and the fuselage shell. Third bars disposed beneath the floor structure transfer forces extending in a. vertical direction between the floor structure and the fuselage shell. Fourth bars each connect an end of a transverse beam to a fuselage frame so as to transfer forces extending in the vertical direction between the floor structure and the shell.

### CROSS REFERENCE TO RELATED APPLICATIONS

This application is a U.S. National Phase application under 35 U.S.C. §371 of International Application No. PCT/DE2011/000361, filed on Apr. 6, 2011, and claims benefit to German Patent Application No. DE 10 2010 014 302.2, filed on Apr. 9, 2010. The International Application was published in German on Oct. 13, 2011, as WO/2011/124207 under PCT Article 21 (2).

### FIELD

The present invention relates to an aircraft including a fuselage shell, a floor structure and a fastening arrangement for supporting the floor structure on the fuselage shell.

### BACKGROUND

When installing a prefabricated floor in a prefabricated aircraft fuselage, the traditional installation method, in which the transverse beams of the floor structure are securely riveted to the fuselage frames, poses a problem with respect to compensating for the different manufacturing tolerances which arise when fitting the fuselage frames in the aircraft body on the one hand and when assembling the floor structure on the other hand. Amongst other things, the fastening holes are only produced in the fuselage frames or in the transverse beams of the floor structure when the floor is fitted in the fuselage. However, if the fuselage frames and/or the transverse floor beams are made from carbon fibre composite material, very fine carbon dust arises during this assembly process which can subsequently only be removed from the aircraft with difficulty. This emission of carbon dust not only poses a health risk to individuals involved in the assembly process, with the result that corresponding precautionary measures need to be taken, but the fine carbon dust which arises during drilling and which cannot be extracted and is deposited in the aircraft, may lead to corrosion on aluminium components or to short-circuits in electrical components.

To avoid these problems, EP 2 030 891 A2 proposed that the floor frame should be fastened to the aircraft fuselage structure exclusively using bars. In this process, the bars were attached to prefabricated fastening points on the fuselage frames and the transverse beams and a tolerance compensation was achieved by being able to adjust the length of these fastening bars. In this known method of fastening the floor frame to the aircraft fuselage, two groups of bars were used, i.e. first bars which extend over the horizontal plane of the floor structure and transfer forces in the transverse direction and in the longitudinal direction of the aircraft between the floor structure and the fuselage shell, and second bars which connect the transverse floor beams to the fuselage frames beneath the floor structure and transfer forces in the vertical direction, i.e. forces parallel to the vertical axis of the aircraft, between the floor structure and the fuselage shell. The bars which support the floor in the vertical direction are in this case located at a lateral distance from the ends of a respective transverse beam, each transverse beam being supported by two vertical bars. It is not possible to provide additional bars beneath the floor to support vertical forces, as otherwise free passage in the hold located beneath the floor which is required for loading and unloading of baggage containers or cargo containers can no longer be guaranteed.

One disadvantage of this fastening arrangement is that the loads applied to the floor generate considerable bowing in the centre of the transverse beams and thus cause a large bending moment in the centre of the transverse beams, the bending moment continuing to rise from the contact point with the vertical support bars towards the centre of the transverse beams. This bending moment is considerably higher than the bending moment which is applied to a transverse beam riveted directly to the fuselage frame in the traditional manner.

This bending moment distribution which arises in the fastening arrangement of EP 2 030 891 A2 is disadvantageous, especially if the transverse beams of the floor structure are to be made from carbon fibre composite material to save weight, as the transverse beams need to be reinforced accordingly and thus the weight benefit which can be achieved by the carbon fibre composite structure is partially removed.

US 2008/0217478 A1 describes a fastening arrangement for the floor in an aircraft, providing fastening flanges pointing inwards obliquely downwards and obliquely upwards on the left and right of the fuselage frame, these flanges supporting a U-shaped mounting rail which extends in the longitudinal direction of the aircraft on the left and right inner side of the fuselage. The opening in this rail is directed in this case towards the middle of the aircraft so that the floor in the form of a honeycomb plate can be pushed into the rails.

### SUMMARY

In an embodiment, the present invention provides an aircraft comprising including a fuselage shell with fuselage frames, a floor structure with transverse beams and longitudinal beams, and a fastening arrangement for supporting the floor structure on the fuselage shell. The fastening arrangement includes first bars each connecting an end of a respective transverse beam of the floor structure to a respective fuselage frame of the fuselage shell so as to transfer forces extending in a transverse direction (y direction) of the aircraft parallel to a transverse axis of the aircraft between the floor structure and the fuselage shell. Second bars each connect an end of a respective transverse beam of the floor structure to a respective fuselage frame of the fuselage shell so as to transverse forces extending in a longitudinal direction (x direction) of the aircraft parallel to a longitudinal axis of the aircraft between the floor structure and the fuselage shell. Third bars are disposed beneath the floor structure and are configured to transfer forces extending in a z direction of the aircraft parallel to a vertical axis of the aircraft between the floor structure and the fuselage shell. The fastening arrangement also includes fourth bars each connecting a respective end of a transverse beam of the floor structure to a respective fuselage frame of the fuselage shell so as to transfer forces extending in the z direction of the aircraft parallel to the vertical axis of the aircraft between the floor structure and the fuselage shell.

### BRIEF DESCRIPTION OF THE DRAWINGS

Exemplary embodiments of the invention are described and explained below in greater detail with reference to the attached drawings, in which:

FIG. 1 shows a perspective detailed inside view of a first embodiment of an aircraft according to the invention with the fastening arrangement according to the invention;

FIG. 2 shows a view of a second embodiment of the fastening arrangement according to the invention viewed in the longitudinal direction of the aircraft;

FIG. 3 shows detail III from FIG. 2; and

FIG. 4 shows a view of the end of a transverse beam in the direction of arrow IV in FIG. 3.

### DETAILED DESCRIPTION

An aspect of the present invention is to specify a generic aircraft and a generic fastening arrangement in which the advantage(s) of the prior art as known from EP 2 030 891 A2 are realised, but a favourable bending moment distribution is also guaranteed in the transverse beams of the floor structure.

In an embodiment of the invention, an aircraft comprising a fuselage shell that has fuselage frames and a floor structure that has transverse beams and longitudinal beams is provided with a fastening arrangement for supporting the floor structure on the fuselage shell, the fastening arrangement comprising multiple groups of bars connecting the floor structure to the fuselage shell.

The first bars each connect an end of a transverse beam to a fuselage frame and transfer forces extending in the transverse direction of the aircraft parallel to the transverse axis of the aircraft between the floor structure and the fuselage shell.

The second bars each connect an end of a transverse beam to a fuselage frame and transfer forces extending in the longitudinal direction of the aircraft parallel to the longitudinal axis of the aircraft between the floor structure and the fuselage shell.

The third bars, which are located beneath the floor structure, transfer forces extending parallel to the vertical axis of the aircraft between the floor structure and the fuselage shell.

According to embodiments of the invention, fourth bars are also provided in the fastening arrangement, each connecting an end of a transverse beam to a fuselage frame and transferring forces extending in the vertical direction of the aircraft, i.e. parallel to the vertical axis of the aircraft, between the floor structure and the fuselage shell.

When forces oriented in a specific direction are mentioned in this patent application, this also covers forces made up of force components which are also oriented in this direction.

This provision of additional fourth bars according to the invention to support forces extending in the direction of the vertical axis of the aircraft or parallel to this direction, not only by the third bars, but also by the fourth bars provided at each respective side end of the transverse floor beams, leads to a clearly more advantageous bending moment distribution in the respective transverse floor beam. In this case the bending moment is in the centre of the transverse beam and thus the resulting bowing at this point is much less than in the configuration according to EP 2 030 891 A2. The transverse floor beam can therefore be constructed to be considerably lighter in the solution according to the invention.

In a preferred embodiment of the invention, the first bars and the second bars extend in the plane of the floor structure and the fourth bars extend in a transverse plane perpendicular to this plane and inclined with respect to the plane of the floor structure.

It is also advantageous if the third bars connect the transverse beams directly to the fuselage frames, each transverse beam being supported on an associated fuselage frame by at least two third bars connected to this beam.

In this case, it is particularly advantageous if the third bars are each attached to a support point on the transverse beam at a distance from the respective end of the transverse beam.

In a particularly preferred embodiment, the respective first bars and the respective second bars all lie in a transverse plane, the first bars and the fourth bars being located at an angle to the plane of the floor structure, and the attachment position of the first bars on the fuselage frame lying above the plane of the floor structure and the attachment position of the fourth bars on the fuselage frame lying beneath the plane of the floor structure. This embodiment has the advantage that both the first bars and the fourth bars are able to support force components in the transverse direction and force components in a direction parallel to the vertical axis of the aircraft.

An embodiment in which at least some of the first bars and/or the second bars and/or the third bars and/or the fourth bars are designed to be adjustable in length is also advantageous. This provides a simple means of adjusting to manufacturing tolerances when installing the floor structure in the aircraft fuselage.

The fastening arrangement according to an embodiment of the invention for supporting a floor structure comprising transverse beams and longitudinal beams on an aircraft fuselage shell that has fuselage frames comprises multiple groups of bars connecting the floor structure to the fuselage shell. The first bars each connect an end of a transverse beam to a fuselage frame and transfer forces extending in the transverse direction (y direction) of the aircraft parallel to the transverse axis of the aircraft between the floor structure and the fuselage shell. The second bars each connect an end of the transverse beam to a fuselage frame and transfer forces extending in the longitudinal direction (x direction) of the aircraft parallel to the longitudinal axis of the aircraft between the floor structure and the fuselage shell. The third bars are located beneath the floor structure and transfer forces extending in the z direction of the aircraft parallel to the vertical axis of the aircraft between the floor structure and the fuselage shell. According to the invention, the fastening arrangement comprises fourth bars, each connecting an end of a transverse beam to a fuselage frame and transferring forces extending in the z direction parallel to the vertical axis of the aircraft between the floor structure and the fuselage shell.

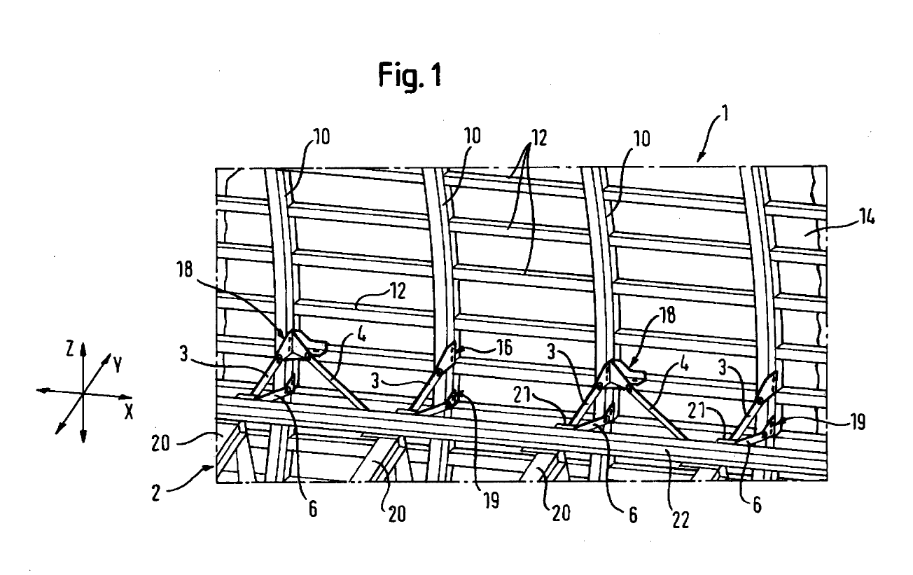

FIG. 1 shows a detail from an aircraft according to an embodiment of the invention as a perspective inside view of the aircraft fuselage. The fuselage shell 1 is formed from substantially annular fuselage frames 10 spaced apart from each other in the longitudinal direction of the aircraft and longitudinal fuselage beams 12 spaced apart from each other in the circumferential direction of the fuselage. A fuselage skin 14 is applied to the outside of the structural framework formed from the fuselage frames 10 and the longitudinal fuselage beams 12. An inner lining of the fuselage shell as usually provided is not shown in FIG. 1.

A floor structure 2 provided inside the fuselage shell 1 is formed from transverse beams 20 and longitudinal beams 22. Only a detail of the floor structure 2 is shown in FIG. 1. After completion, the floor structure 2 is provided with floor panels placed on the transverse beams 20, and the upper side of the longitudinal beams 22 is usually provided with seat rails in which passenger seats can be anchored.

The ends 21 of the transverse beams 20 are each fastened by means of first bars 3 extending in the direction of the transverse beams to an associated fuselage frame 10. Second bars 4 connect the end 21 of a respective transverse beam 20 to a fuselage frame which is adjacent to the fuselage frame 10 associated with this transverse beam 20, so that the second bars 4 extend at an acute angle to the transverse direction of the aircraft, i.e. obliquely to the respective transverse beam 20.

Both the first bars 3 and the second bars 4 lie in the plane of the floor structure, i.e. in the x-y plane of the aircraft. They form a lattice lying in this plane to connect the floor structure 2 to the fuselage shell 1 at the side. Although FIG. 1 only shows a detail of the connection between the floor structure 2 and the fuselage shell 1 on one longitudinal side of the aircraft, the connection is formed in a similar manner on the other longitudinal side.

In order to fasten the first bars 3 to the respective associated fuselage frame 10 or the first bars 3 and the second bars 4 to the respective associated fuselage frame 10, fittings 16 or 18, which are preferably made from titanium, are provided which are fastened to the fuselage shell 1. The fittings 16, which are merely used to attach the first bars 3 to the fuselage shell 1, are only attached to the associated fuselage frame. The fittings 18 which are used both to fasten a first bar 3 and a second bar 4 to the fuselage shell 1 are designed as corner fittings and are attached to a fuselage frame 10 and to an associated longitudinal beam 12. The provision of such fittings 16, 18 is particularly advantageous if the fuselage frames 10 and/or the longitudinal fuselage beams 12 are not made from metal, but from a composite material such as carbon fibre composite material (CFRP).

As shown in the drawing, the first bars 3 extending in the transverse direction are present on each fuselage frame 10 and on each transverse beam 20 on both longitudinal sides of the floor structure. The second bars 4 extending at an oblique angle to the transverse beam 30 are merely attached to each second fuselage frame 10 or to each second transverse beam 20.

The second bars 4 extending at the acute angle (especially in the angular range between 30° and 60°) to the transverse direction transfer forces which extend predominantly in the longitudinal direction x of the aircraft.

Third bars 5 are located beneath the floor structure 2 and extend substantially perpendicular to the x-y plane of the floor structure in the z direction parallel to the vertical axis of the aircraft. The third bars 5 are each laid on the left and right sides of the floor structure beneath an associated transverse beam 20 and connect this beam to the fuselage frame 10 which runs beneath it. The support point at which a third bar 5 is attached to the transverse beam 20 is positioned at a distance from the respective end 21 of the transverse beam 20, looking inwards towards the centre of the aircraft. The third bars 5 are designed to pass forces extending in the z direction perpendicular to the x-y plane of the floor structure 2 to the fuselage shell 1.

In the fastening arrangement shown in FIG. 1, fourth bars 6 are further provided which also connect the end 21 of each transverse beam 20 to the fuselage frame 10 adjacent to this end 21, but which extend at an acute angle to the x-y plane of the floor structure 2. The first bars 3 and the fourth bars 6 are thus positioned on a shared transverse plane (y-z plane). The fourth bars 6 are also attached to the respective fuselage frame 10 by means of fittings 19.

Whereas the first bars 3 can only transfer forces arising in the y direction, i.e. in the transverse direction, from the floor structure 2 to the fuselage shell 1, the fourth bars 6 which are positioned obliquely are able to support force components extending in the z direction between the floor structure 2 and the fuselage shell 1 in addition to transverse force components extending in the y direction. The forces extending in the z direction between the floor structure 2 and the fuselage shell 1 are thus supported both by the third bars 5 in the form of support bars located beneath the floor structure 2 and by the fourth bars 6 extending obliquely to the plane of the floor structure 2 and engaging with the respective end 21 of the transverse beams 20, which leads to an improved bending moment distribution in the respective transverse beam 20 and reduces bowing of the transverse beam 20 considerably.

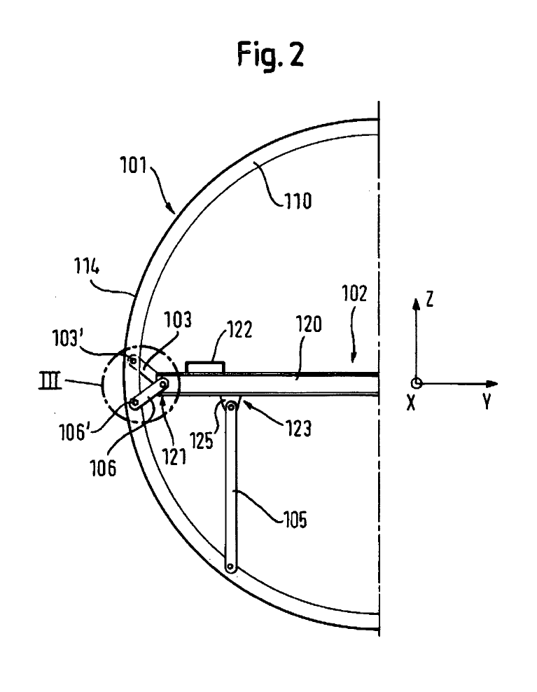

An alternative embodiment of the aircraft according to the invention and the fastening arrangement according to the invention is described below in conjunction with FIGS. 2 to 4. The reference numerals for identical components are increased by 100 in this case.

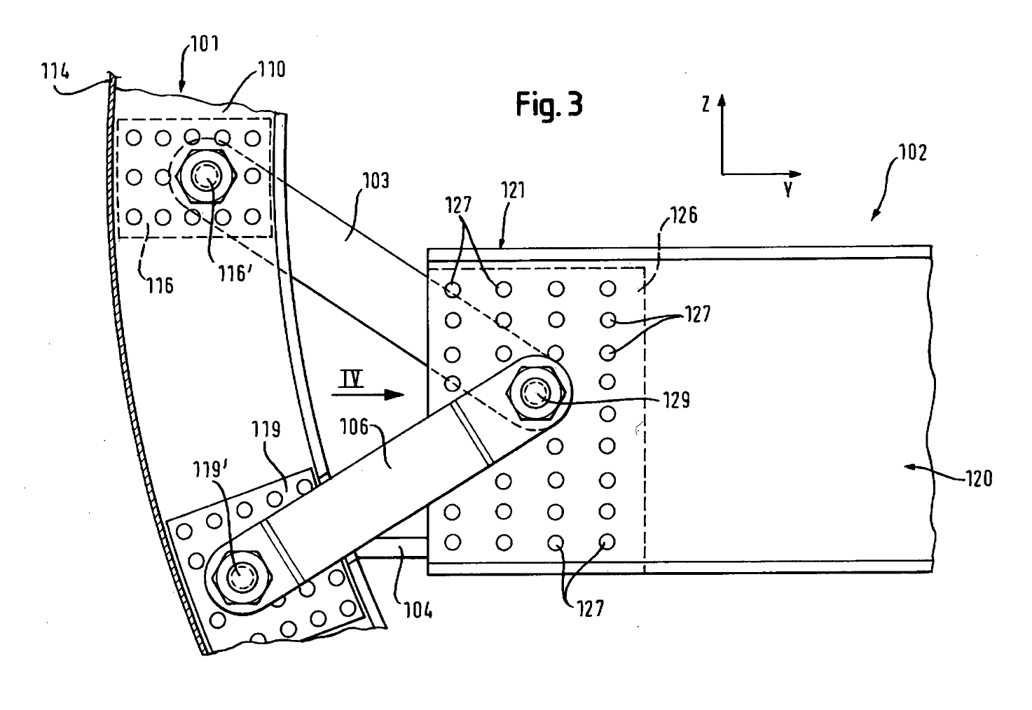

FIG. 2 is a schematic representation of a vertical section through the fuselage of an aircraft, e.g. an aeroplane, on one side of the fuselage. The other side is formed as a mirror image and is therefore not shown. FIG. 3 shows detail III from FIG. 2 in an enlarged view.

The fuselage shell 101 comprises substantially circular fuselage frames 110, the fuselage skin 114 being applied on the radial outer side of these frames. A floor structure 102 is inserted inside the fuselage, this floor structure being connected to the fuselage shell 101 via bars. The floor structure 102 comprises transverse beams 120 and longitudinal beams 122 and is lined on its upper side with floor panels (not illustrated) which form the floor of a passenger cabin.

The transverse beams 120 are each connected to an adjacent fuselage frame at each of their two ends 121 via first bars 103 and fourth bars 106. The attachment position 103′ for the first bars 103 on the fuselage frame 110 is located above the x-y plane of the floor structure 102 and the attachment position 106′ for the fourth bars 106 is located beneath the x-y plane. In this way, both the first bars 103 and the fourth bars 106 can pass forces directed sideways (in the y direction) and forces directed vertically (in the z direction) from the floor structure 102 into the fuselage frame 110. As in the first embodiment illustrated in FIG. 1, a second bar 104 is also attached at its respective side end 121 to each second transverse beam 120 in the second embodiment illustrated in FIG. 2 and this bar extends in the x-y plane, leading to an annular former 110 where it is fastened, this annular former being adjacent to the annular former connected to the first bar 103 and the fourth bar 106 in the longitudinal direction of the aircraft. The second bar 104 is therefore able to pass transverse forces extending in the y direction and longitudinal forces extending in the x direction from the floor structure 102 into the fuselage structure 101.

Third bars 105 are provided beneath the floor structure 102 and these pass the forces from the floor structure 102 to the fuselage shell 101 in the vertical direction (z direction). The third bars 105 are attached to a support point 123 at a distance from the respective end 121 of the transverse beam 120 by means of fastening straps 125 on the transverse beam 120 and extend downwards in the z direction, where the other end of the fastening strap 105 is connected to the associated annular former 110.

Some or all of the fastening straps 103, 104, 105, 106 can be formed such that they are adjustable in length in a manner known to a person skilled in the art so that they can compensate for manufacturing tolerances when installing the floor structure 102 in the fuselage shell 101.

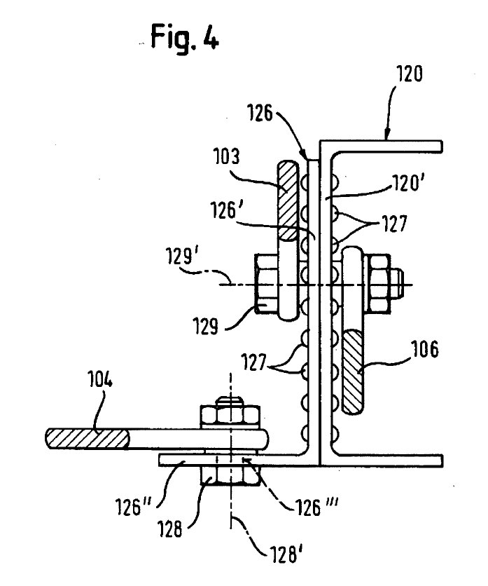

The means of fastening the first bars 103, the second bars 104 and the fourth bars 106 to the transverse beam 120 and to the fuselage frame 110 is explained below in conjunction with FIGS. 3 and 4.

The transverse beam 120 is designed with a reinforcement strap 126 in the form of an angle at each of its two side ends and this strap is firmly connected to the transverse beam 120 by a large number of rivets 127. For this purpose, a vertical leg 126′ of the strap 126 is brought into contact with the vertical middle section 120′ of the transverse beam 120 and riveted to this beam. A horizontal lower portion 126″ of the strap 126 extends parallel to the x-y plane and comprises a mounting hole 126″' in which the second bar 104 is fastened by means of a screw bolt 128 such that it can be pivoted slightly around the axis 128′ of the screw bolt in order to compensate for manufacturing tolerances.

The first bar 103 and the fourth bar 106 are also fastened to the transverse beam 120 in the vicinity of the strap 126 by means of a further screw bolt 129 which passes through an attachment hole in the transverse beam 120 and in the strap 126 such that they are able to execute a slight pivoting movement around the longitudinal axis 129′ of the screw bolt 129, which also serves to compensate for manufacturing tolerances.

In the region where the first bar 103 is attached to the fuselage frame 110, the fuselage frame 110 is furnished with a metal reinforcement plate 116, which is provided in particular if the fuselage frame is made from a carbon fibre composite material. The first bar 103 is fastened to the fuselage frame by means of a bolt 116′ passing through the wall of the fuselage frame and the reinforcement plate, which also makes it possible for the first bar 103 to pivot slightly around the axis of the bolt 116′. If the wall of the fuselage frame 110 is not to be weakened by providing a penetrating hole for the bolt 116′, the reinforcement plate 116, as shown in FIG. 1, may be in the form of a strap and the first bar 103 may be articulated at the portion of this strap protruding inwards over the fuselage frame by means of the bolt.

A reinforcement plate 119 is also provided in the region where the fourth bar 106 is fastened to the fuselage frame 110 and this plate is connected to the fuselage frame 110 by a large number of rivets. The fourth bar 106 is articulated by means of a bolt 119′ penetrating the wall of the fuselage frame 110 and the reinforcement plate 119 on the fuselage frame 110 in the same manner as the first bar 103. This articulation point for the fourth bars 106 may also be provided at a portion of the metal fastening plate 119 in the form of a strap protruding over the fuselage frame as shown in FIG. 1 by way of example, so that here too the fuselage frame is not weakened by a fastening hole.

Reference numerals in the claims, the description and the drawings are provided solely to facilitate understanding of the invention and should not restrict the scope of protection.

While the invention has been particularly shown and described with reference to preferred embodiments thereof, it will be understood by those skilled in the art that various changes in form and details may be made therein without departing from the spirit and scope of the invention.

### LIST OF REFERENCE NUMERALS

1 fuselage shell
2 floor structure
3 first bars
4 second bars
5 third bars
6 fourth bars
10 fuselage frame
12 longitudinal fuselage beam
14 fuselage skin
16 fittings
18 fittings
19 fittings
20 transverse beam
21 end of transverse beam 20
22 longitudinal beam
30 transverse beam
101 fuselage shell
102 floor structure
103 first bars
103′ attachment position for first bars 103
104 second bars
105 third bars
106 fourth bars
106′ attachment position for fourth bars 106
110 fuselage frame
114 fuselage skin
116 reinforcement plate
116′ bolt
119 reinforcement plate
119′ bolt
120 transverse beam
120′ middle section
121 end of transverse beam 120
122 longitudinal beam
123 support point
125 fastening straps
126 reinforcement strap
126′ vertical leg
126″ horizontal lower portion
126′″ mounting hole
127 rivets
128 screw bolt
128′ axis of screw bolt 128
129 screw bolt
129′ longitudinal axis of screw bolt 129

1-12. (canceled)

13: An aircraft comprising
a fuselage shell including fuselage frames;
a floor structure including transverse beams and longitudinal beams; and
a fastening arrangement for supporting the floor structure on the fuselage shell, the fastening arrangement including:
first bars each connecting an end of a respective transverse beam of the floor structure to a respective fuselage frame of the fuselage shell so as to transfer forces extending in a transverse direction (y direction) of the aircraft parallel to a transverse axis of the aircraft between the floor structure and the fuselage shell,
second bars each connecting an end of a respective transverse beam of the floor structure to a respective fuselage frame of the fuselage shell so as to transverse forces extending in a longitudinal direction (x direction) of the aircraft parallel to a longitudinal axis of the aircraft between the floor structure and the fuselage shell,
third bars disposed beneath the floor structure and configured to transfer forces extending in a z direction of the aircraft parallel to a vertical axis of the aircraft between the floor structure and the fuselage shell, and
fourth bars each connecting a respective end of a transverse beam of the floor structure to a respective fuselage frame of the fuselage shell so as to transfer forces extending in the z direction of the aircraft parallel to the vertical axis of the aircraft between the floor structure and the fuselage shell.

14: The aircraft recited in claim 13, wherein the first bars and the second bars extend in a plane (x-y plane) of the floor structure the fourth bars extend in a transverse plane (y-z plane) of the aircraft perpendicular to the x-y plane of the floor structure and are inclined with respect to the x-y plane.

15: The aircraft recited in claim 13, wherein the third bars connect the transverse beams of the floor structure to the fuselage frames of the fuselage shell, each transverse beam being supported by at least two third bars connected to the respective brain on an associated fuselage frame.

16: The aircraft recited in claim 15, wherein the third bars are each attached to a support point on the respective transverse beam at a distance from the respective end of the transverse beam.

17: The aircraft recited in claim 13, wherein the respective first bars and the respective fourth bars are disposed together in a transverse plane (y-z plane) and in that the first bars (103) and the fourth bars (106) are arranged at an angle to the plane (x-y plane) of the floor structure (102), the attachment position for the first bars (103) on the fuselage frame (110) being located above the x-y plane and the attachment position for the fourth bars (106) on the fuselage frame (110) being located beneath the x-y plane.

18: The aircraft recited in claim 13 wherein at least some of the first, second, third and fourth bars are adjustable in length.

19: A fastening arrangement for supporting a floor structure having transverse and longitudinal beams on a fuselage shell of an aircraft that has fuselage frames, the fastening arrangement comprising:
first bars each connecting an end of a respective transverse beam of the floor structure to a respective fuselage frame of the fuselage shell so as to transfer threes extending in a transverse direction (y direction) of the aircraft parallel to a transverse axis of the aircraft between the floor structure and the fuselage
second bars each connecting an end of a respective transverse beam of the floor structure to a respective fuselage frame of the fuselage shell so as to transverse forces extending in a longitudinal direction (x direction) of the aircraft parallel to a longitudinal axis of the aircraft between the floor structure and the fuselage shell,
third bars disposed beneath the floor structure and configured to transfer forces extending in a z direction of the aircraft parallel to a vertical axis of the aircraft between the floor structure and the fuselage shell, and
fourth bars each connecting a respective end of a transverse beam of the floor structure to a respective fuselage frame of the fuselage shell so as to transfer forces extending in the z direction of the aircraft parallel to the vertical axis of the aircraft between the floor structure and the fuselage shell.

20: The fastening arrangement recited in claim 19, wherein the first bars and the second bars extend in a plane (x-y plane) of the floor structure the fourth bars extend in a transverse plane (y-z plane) of the aircraft perpendicular to the x-y plane of the floor structure.

21: The fastening arrangement recited in claim 19, wherein the third bars connect the transverse beams of the floor structure to the fuselage frames of the fuselage shed, each transverse beam being supported by at least two third bars connected to the respective beam on an associated fuselage frame.

22: The fastening arrangement recited in claim 21, wherein the third bars are each attached to a support point on the respective transverse beam at a distance from the respective end of the transverse beam.

23: The fastening arrangement recited in claim 19, wherein the respective first bars and the respective fourth bars are disposed together in a transverse plane (y-z plane) and in that the first bars (103) and the fourth bars (106) are arranged at an angle to the plane (x-y plane) of the floor structure (102), the attachment position for the first bars (103) on the fuselage frame (110) being located above the x-y plane and the attachment position for the fourth bars (106) on the fuselage frame (110) being located beneath the x-y plane.

24: The fastening arrangement recited in claim 19 wherein at least sonic of the first, second, third and fourth bars are adjustable in length.
